(19) United States
(12) Patent Application Publication
(10) Pub. No.: US 2017/0214642 A1
(43) Pub. Date: Jul. 27, 2017

(54) SYSTEMS AND METHODS FOR MANAGING DELIVERY OF MEDIA CONTENT TO USER COMMUNICATION TERMINALS

(71) Applicant: VONAGE NETWORK LLC, Holmdel, NJ (US)

(72) Inventors: Royee Uriel Tichauer, Haifa (IL); Iliya Barenboim, Ramat Gan (IL); Lihi Gendelis, Tel Aviv-Yafo (IL)

(21) Appl. No.: 15/007,442

(22) Filed: Jan. 27, 2016

(51) Int. Cl. H04L 12/58; H04L 29/06; H04L 29/08

(52) U.S. Cl. CPC H04L 51/08; H04L 67/1097; H04L 51/04; H04L 51/22; H04L 67/02; H04L 69/22

(57) ABSTRACT

Methods for managing delivery of media files comprise receiving, at a server, a request for delivery of a media file to a first recipient, determining that the media file lacks association with a unique identifier, storing a copy of the media file, associating a unique identifier with the media file, making available, to the first recipient, the stored copy, receiving, at the server, a second request to deliver the media file, determining that the copy of the media file is associated with the unique identifier, and making available, to a second recipient, the stored copy. Related methods for managing delivery of media files comprises determining, by execution of instructions by a processor, that user input received at a communication terminal specifies a media file, determining that the media file is identified by a unique identifier; and transmitting, to a server, a message comprising the message content and the unique identifier.

### BACKGROUND

Field

Embodiments consistent with the present invention generally relate to methods and apparatus for delivering media content to one or more communication terminals.

Description of the Related Art

Over the course of a day, a user of a display-equipped communication terminal such, for example, as a mobile phone, smartphone, tablet computer, personal digital assistant, or laptop, notebook, or desktop computer (each, a “user communication terminal”) may create, forward and/or receive a large number of text, chat, and/or e-mail messages. Increasingly, such users often utilize such messages as a convenient and facile way of sharing digital media content such as images, video, documents, spreadsheets, presentations and the like.

A user may attach or otherwise include one or more media files to a single message addressed to many recipients. Alternatively, or in addition, that same user may author multiple messages, each addressed to a single intended recipient, as a way to distribute one or media files. An item of media content is typically regarded as having “gone viral” after many users have included the same media content file (or a network address from which that media content file can be accessed) in a message sent to other recipients.

The inventors herein have observed that users of a messaging system may upload and/or download the same media content file(s) multiple times. This redundancy in data transfer places a burden on such server resources as processing speed and data storage.

Accordingly, there is a need for improved methods and systems for managing the delivery of media content to those using a communication terminal to access one or more messages, and for facilitating the creation and/or forwarding of messages specifying such delivery.

### SUMMARY

The inventors herein propose systems and methods operative to selectively designate, for delivery to one or more recipients, media files locally stored at or accessible from a communication terminal and, where such media files are already associated with a respectively unique identifier at the communication terminal, to automatically substitute the applicable unique identifier for the media file itself when processing requests to upload such media file(s) from the communication terminal.

In some embodiments, a computer implemented method of managing delivery of media files comprises initiating storage of a copy of the media file; associating a unique identifier with the media file; making available, to the first recipient, the stored media file copy; receiving, at the server, a second request to deliver the media file; determining that the copy of the media file is associated with the unique identifier; and making available, to a second recipient, the stored media file copy.

In some embodiments, a computer implemented method comprises, at a first communication terminal, receiving user input corresponding to an identification of one or more recipients and to message content; initiating display of the message content according to a user interface; determining, by execution of instructions by a processor of the first communication terminal, that the received user input specifies a media file; determining that the media file is identified by a unique identifier; and transmitting, to a server, a message comprising the message content and the unique identifier.

In some embodiments, a system for managing delivery of media files comprises a display, a transceiver, a processor, and a memory containing instructions executable by the processor to receive user input corresponding to an identification of one or more recipients and to message content, to initiate display of the message content according to a user interface, to determine that received user input specifies a media file, to determine that the specified media file is identified by a unique identifier, and to initiate transmission, to a server, of a message comprising the message content and the unique identifier.

Other and further embodiments of the present invention are described below.

### BRIEF DESCRIPTION OF THE DRAWINGS

So that the manner in which the above recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a block diagram depicting a communication system configured to aid message authors in the selective creation of messages which facilitate the efficient transfer of media files, according to one or more network centric embodiments;

FIG. 1B depicts a block diagram of a communication system configured to aid message authors in the selective creation of messages which facilitate the efficient transfer of media files, according to one or more communication terminal (e.g. “endpoint”) centric embodiments;

FIG. 1C is a block diagram depicting, in greater detail, the interaction between functional components according to some embodiments exemplified by FIG. 1A;

FIG. 2 is a flow diagram of a method for managing the creation of message content specifying one or more media file attachments, at a first or “sender” user communication terminal, to facilitate efficient delivery of media files according to one or more embodiments consistent with the present disclosure;

FIG. 3 is a flow diagram of a method for specifying one or more media file unique identifiers to facilitate efficient delivery of media files to one or more recipient communication terminals, as, for example, a sub-process of the method of FIG. 2, according to one or more embodiments consistent with the present disclosure;

FIG. 4 is a flow diagram of a method for associating one or more media file unique identifiers with one or more corresponding media files to facilitate efficient delivery of media files to one or more recipient communication terminals, as, for example, a sub-process of the method of FIG. 2, according to one or more embodiments of consistent with the present disclosure;

FIG. 5 is a flow diagram of a method for associating one or more media file unique identifiers with one or more corresponding media files to facilitate efficient delivery of media files to one or more recipient communication terminals, as, for example, a sub-process of the method of FIG. 2, according to one or more embodiments consistent with the present disclosure;

FIG. 6 is a flow diagram of a method for processing and/or presenting received messages, specifying one or more media files to be sent to one or more recipients, to facilitate the efficient transfer of media files to recipient communication terminals, according to one or more embodiments consistent with the present disclosure;

FIG. 7A is a message flow diagram depicting the development, flow and processing of messages between a user of a first communication terminal and a user of a second communication terminal, at least some of the messages specifying media files and/or media file addresses to facilitate the efficient delivery of such media file(s) to the recipient(s) according to one or more embodiments;

FIG. 7B is message flow diagram depicting the development, flow and processing of messages between a user of the second communication terminal depicted in FIG. 7A and user of a third communication terminal, at least some of the messages specifying media files and/or media file addresses to facilitate the efficient delivery of such media file(s) to the recipient(s) according to one or more embodiments;

FIG. 8A depicts a communication terminal operated by a user to visually present a sequence of messages forming at least part of a first message exchange between two or more participants and to create, edit or forward a message containing a media file attachment and/or specifying a unique media file identifier for enhancing the efficiency of a media file exchange, according to one or more embodiments;

FIG. 8B depicts the communication terminal of FIG. 8A following the processing of received message content and selection of a media file to be included as a message attachment for delivery to a first recipient, according to one or more embodiments;

FIG. 8C depicts the communication terminal of FIGS. 8A and 8B operated by a user to construct a message intended for a second recipient;

FIG. 8D depicts the communication terminal of FIGS. 8A to 8C operated by a user to construct a message intended for the second recipient but specifying the same media file content as that specified for delivery to a first recipient as shown in FIG. 8B, according to one or more embodiments; and

FIG. 9 is a detailed block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention include a system and method for generating and/or processing messages, which specify and/or include one or more media file attachments, to facilitate the efficient delivery of the media file(s) to one or more message recipients. Some exemplary embodiments consistent with the claimed invention improve upon standard message exchange and group chat client application functionality by enabling a message author to specify one or more file attachments in the message but to automatically substitute a unique identifier for any specified attachment(s) with which the unique identifier is associated. In embodiments, the substitution requires no involvement or awareness on the part of the message author.

Based on the inclusion of a unique identifier in a message, according to some embodiments, a server retrieves a stored copy of the media file and then forwards that retrieved copy to the intended recipients specified in the message. The first time a media file is to be sent by a particular communication terminal user, a unique identifier may be locally generated at the communication terminal and forwarded to the server with the media file. Alternatively, the media file alone may be sent to the server and the unique identifier assigned afterward.

Various embodiments of systems and methods for administering and distributing message content and media files based on the availability of a corresponding unique identifier associated with the media file (s) are provided below. In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

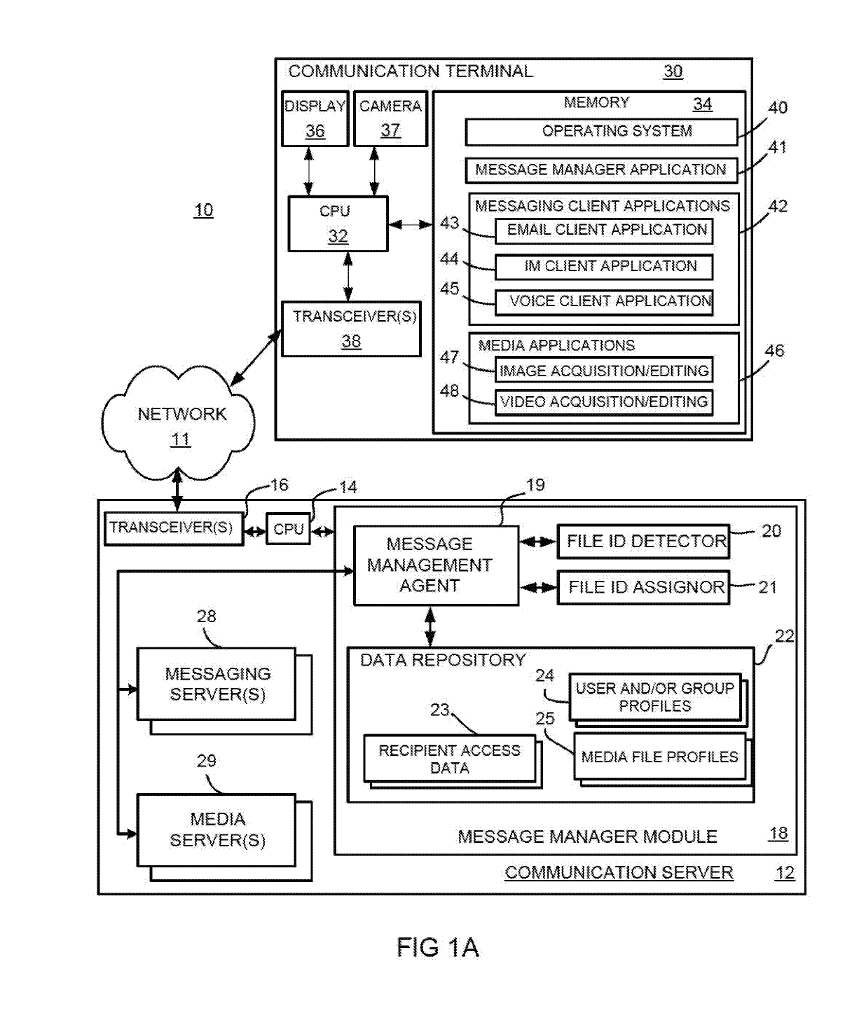

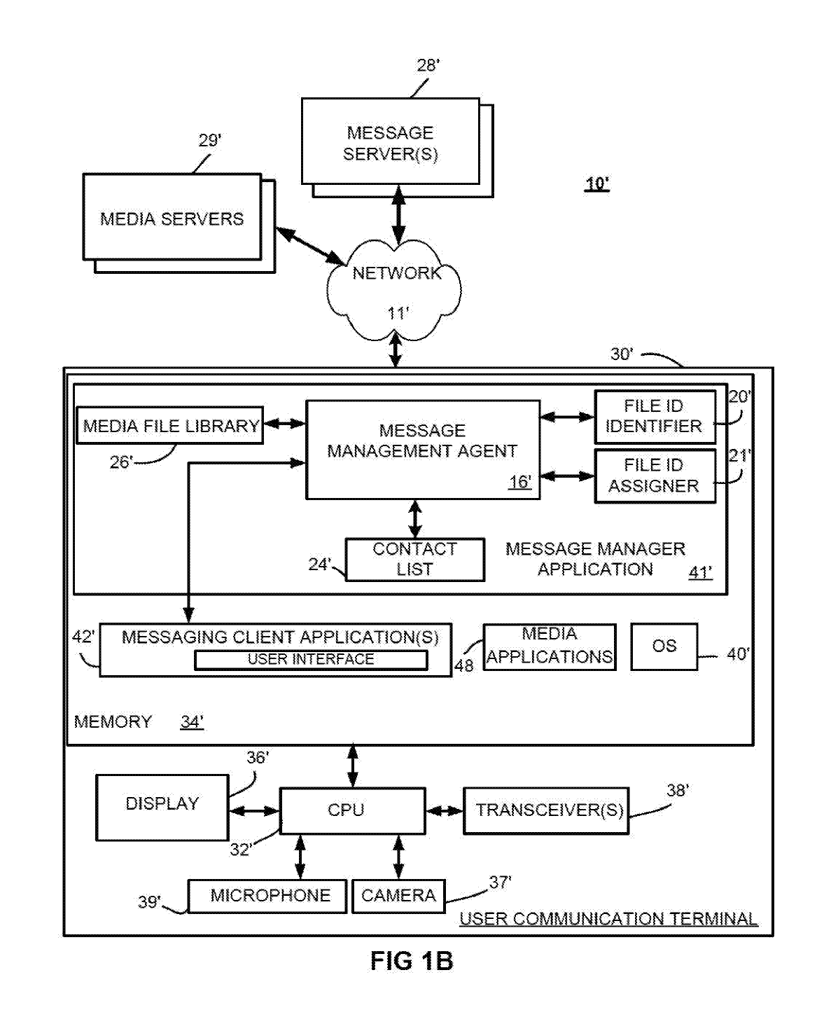

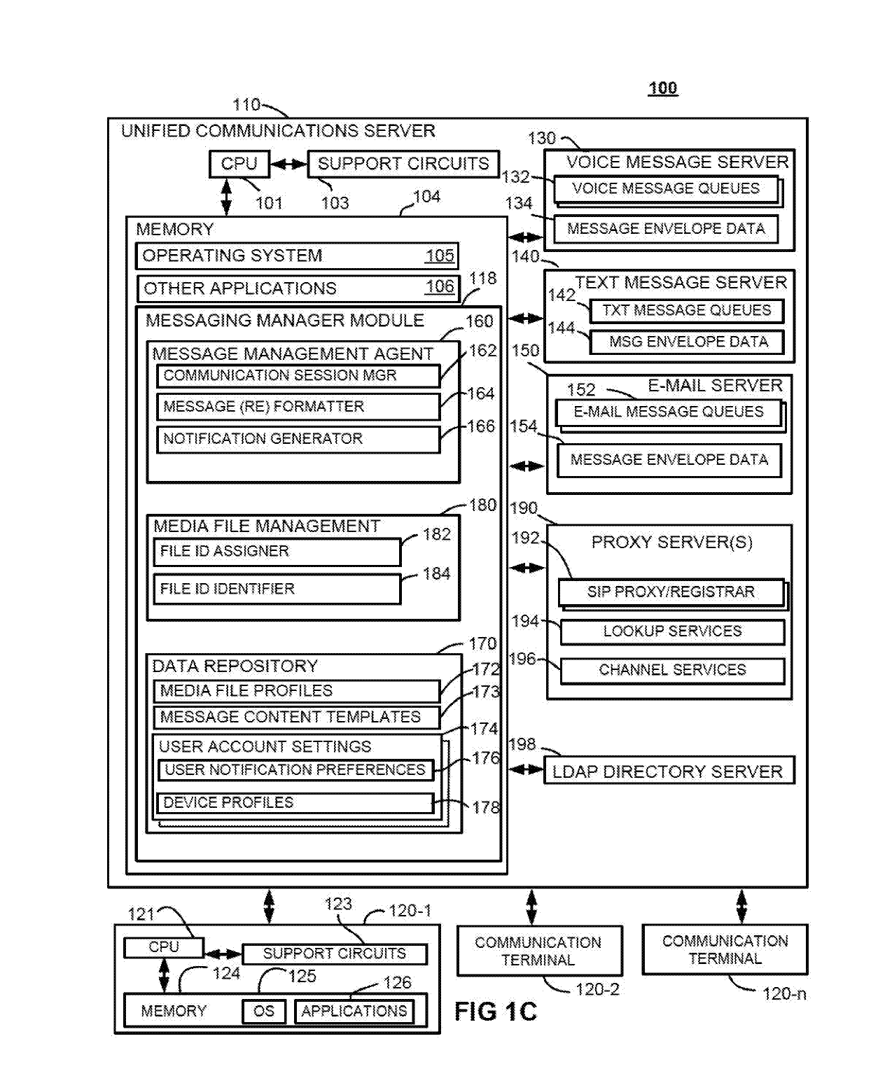

FIG. 1A is a block diagram depicting a communication system 10 configured to aid message authors in the selective creation of messages which facilitate the efficient transfer of media files, according to one or more network centric embodiments. According to some embodiments, communication system 10 includes a unified communication server 12 having a message manager module 18, one or more processors as CPU 14, transceiver(s) 16 for establishing communication links with one or more user communication terminals, as communication terminal 30, via communication network 11. Message manager module 18 includes a unified communication (UC) message management agent 19 configured to examine and process messages which, in addition to message content intended for one or more recipients, may also contain one or more media file attachments and/or unique identifiers corresponding to such media file attachments. In embodiments, message manager module 18 further includes a data repository 22 which comprises one or more databases containing recipient access data 23, user and/or group profiles 24, and media file profiles 25.

According to one or more embodiments, message manager module 18 further includes a File ID detector 20 for inspecting the file name of each specified media file received via, for example, one of messaging servers 28, to determine if a unique media file identifier is already associated with the specified media file. In an embodiment, a file naming convention may be utilized by which a pre-existing file name of a media file is modified so as to include specific fields from which the unique file identifier and, optionally, a date of creation or last modification may be determined. A copy of each media file so identified is stored in one or more media servers 29. In some embodiments, message manager module 18 further includes a File ID Assignor 21 for renaming each media file not previously received (or otherwise processed) by communication server 12 such that when such media files are received as, for example, an attachment to a message received by one of messaging servers 28, a copy having a file name complying with the file naming convention is created and stored in one of media server(s) 29.

In other embodiments, instead of relying upon a naming convention, a separate media file record is created and stored within media file profile database 25, the media file record including the file name for each media file, the media file creation date, the identity of each sender and recipient of the media file, and a unique file identifier. In yet other embodiments, the media files stored on media server 29 themselves may be populated with metadata to facilitate identification.

In accordance with some embodiments of the present disclosure, the presence of a unique identifier in a message received from a communication terminal as communication terminal 30 triggers the message management agent 19 to retrieve the applicable media file copy or copies from media server(s) 29 and reformat the message from the sender such that it includes the media file copy or specifies an address (e.g. a uniform resource locator or URL address) from which the message recipient(s) may download the media file copy.

In an embodiment, media servers 29 of system 10 include, by way of illustrative example, an email server, a text messaging and/or chat server, a short messaging service (SMS) server, or a voice mail server and corresponding speech to text processor. To make use of some or all of the services supported by messaging server(s) 28, each communication terminal 30 includes messaging client applications 42 which may include an e-mail client application 43, an instant messaging (IM) client application 44, and a voice client application 45. To facilitate the acquisition and/or editing of media files, each communication terminal 30 may further include such media applications 46 as an image acquisition/editing application 47 and/or a video acquisition/editing application 48. In some embodiments, either of the media applications may be used to operate an onboard image acquisition device such as camera 37.

Communication terminal 30 includes one or more processors, as CPU 32, for executing instructions stored in memory 34 as, for example, those corresponding to operating system 40, messaging manager application 41, as well as the aforementioned messaging client applications 42 and media applications 46. Communication terminal 30 further includes a display 36 and one or more transceivers 38 for establishing a communication link with, for example, communication server 12 via network 11. By way of illustrative example, network 11 may comprise a Wide Area Network (WAN) and/or a Metropolitan Area Network (MAN), which includes a communication system that connects computers (or devices) by wire, cable, fiber optic and/or wireless links facilitated by various types of well-known network elements, such as hubs, switches, routers, and the like. The network 11 may also be part of a Local Area Network (LAN) using various communications infrastructure, such as Ethernet, Wi-Fi, a personal area network (PAN), a wireless PAN, Bluetooth, Near field communication, and the like.

In some embodiments, the unified communication server 12 comprises one or more network transceivers 16 comprising, for example, transmission and receiving devices as transceivers compliant with corresponding transport or transmission protocol(s) such as IEEE 802.11, IEEE 802.13, BLUETOOTH, and/or cellular transmission protocols such as Code Division Multiple Access (CDMA), Time Division Multiple Access (TDMA) and/or Global System for Mobile communications (GSM). In embodiments, a communication session module (not shown) is configured, by execution of instructions by a processor, to perform functions of a SIP (Session Initiation Protocol) Proxy/Registrar, message exchange service, Group Chat Server lookup service, and/or Group Chat Server channel service. In addition or alternatively, the communication session module in some embodiments of system 10 is configured, by execution of instructions by a processor, to forward a telephone call or to send an SMS, MMS or IM chat message to one or more intended recipients via a communications network. Message manager module 18 and messaging servers 28 are, in some embodiments, resident in memory as instructions executable by CPU 14.

FIG. 1B depicts a block diagram of a communication system 10′ configured to aid message authors in the selective creation of messages which facilitate the efficient transfer of media files, according to one or more communication terminal (e.g. “endpoint”) centric embodiments. The arrangement of and interrelationships between the various functional components of the embodiment of FIG. 1B are very similar to those of the embodiment of FIG. 1A. A principal difference between the respective embodiments is that in the former case, contemporaneous identification of media files not already associated with a unique identifier and processing of messages to include both the media file and such an identifier is performed locally by a message manager application 41′ executed locally on the communication terminals 30′ rather than at a central server. In the illustrative embodiment of FIG. 1A, on the other hand, at least some of the message manager module's functions such, for example, as assigning of the unique identifiers to respective media files, are performed remotely at a central server.

In an embodiment, system 10′ includes one or more communication terminals such as terminal 30′ each having a central processing unit (CPU) 32′, support circuits (not shown), a memory 34′ containing an operating system 40′, one or more messaging client applications 42′ having a user interface and media applications 48 executable by CPU 32′, an associated display 36′, an image capture device such as camera 37′, one or more transceiver(s) 38 for exchanging communication signals via links of communication network 11′, and a microphone 39′. Applications residing in memory 34′ further include message manager application 41′, which contains a message management agent 16′ communicatively coupled by a network connection established via transceivers 38′ to one or more remote messaging server(s) 28′. Also communicatively coupled to the message management agent 16′ are File ID identifier 20′ and File ID assignor 21′, media file library 26′, and a contact list 24′

FIG. 1C is a block diagram depicting, in greater detail, the interaction between functional components in a communication system 100 comprising a unified communications server 110. In some embodiments, the unified communications server 110 includes a voice messaging and/or call server 130, text messaging server 140, e-mail server 150, proxy server(s) 190, and a Lightweight Directory Access Protocol (LDAP) directory server 198. The various components of system 100, including unified communication server 110, and communication terminals 120-1 to 120-n, are connected by one or more network links. Some of the links are established by a network, such as a Wide Area Network (WAN) or Metropolitan Area Network (MAN), which includes a communication system that connects computers (or devices) by wire, cable, fiber optic and/or wireless link facilitated by various types of well-known network elements, such as hubs, switches, routers, and the like. The network interconnecting some components may also be part of a Local Area Network (LAN) using various communications infrastructure, such as Ethernet, Wi-Fi, a personal area network (PAN), a wireless PAN, Bluetooth, Near field communication, and the like.

The various servers 130, 140, 150, 190, and 198 are each a computing device, or may be the same computing device as, for example, a desktop computer, laptop, tablet computer, and the like, or they may be cloud based servers e.g., a blade server, virtual machine, and the like. For each provisioned voice mail user or subscriber, voice mail server 130 maintains a voice mail message queue 132 and message envelope date 134 indicating a date and time when a voice mail message was left for a provisioned user, an identification of the caller or caller's extension (if available), whether and when a voice mail message was forwarded to another extension (a voice message forwarded to another party qualifying as a “response” according to one or more embodiments), and an indication of a date and time when the user first accessed the voice mail. In some embodiments, server 130 further includes a speech-to-text interface (not shown) operative to convert voice messages into email messages.

For each provisioned text messaging, SMS or MMS messaging client, which may accommodate one-to-one, one-to-many, and multiple participant “group” chat message exchanges, messaging manager module/server 140 maintains message queue 142 and message envelope information 144 identifying a message originator's network address, a recipient's network address, the date and time of delivery to each recipient and/or to a group chat “room”, and user account settings including rules and preferences defined by the user.

For each provisioned email user or subscriber, email server 150 maintains an email message queue 152 and message envelope information 154 identifying the sender's email address, each recipient's email address, the date and time of delivery to an email inbox, and user account settings including rules and preferences defined by the user.

According to one or more embodiments, Proxy server(s) 190 and LDAP directory server 198 provides sender and recipient (and/or group) directory lookups as needed to support the exchange of messages between communication terminal endpoints. In some embodiments, proxy server 190 is a SIP proxy server comprising a SIP/Proxy registrar 192, lookup services 194, and channel services 196 which collectively manage processes for authenticating users and managing the exchange of messages between endpoint communication terminals

According to some embodiments, unified communication server 110 includes a messaging manager module 118 comprising a set of instructions residing in memory 104 and executable by a Central Processing Unit (CPU) 101. The CPU 101 may include one or more commercially available microprocessors or microcontrollers that facilitate data processing and storage. Various support circuits 103 facilitate the operation of the CPU 101 and include one or more clock circuits, power supplies, cache, input/output circuits, and the like. The memory 104 includes at least one of Read Only Memory (ROM), Random Access Memory (RAM), disk drive storage, optical storage, removable storage and/or the like.

In addition to message manager module 118, memory 104 includes an operating system 105, and a plurality of applications which may optionally include a speech-to-text converter (not shown). The operating system (OS) 105 generally manages various computer resources (e.g., network resources, file processors, and/or the like). The operating system 105 is configured to execute operations on one or more hardware and/or software modules, such as Network Interface Cards (NICs), hard disks, virtualization layers, firewalls and/or the like. Examples of the operating system 120 may include, but are not limited to, LINUX, MAC OSX, BSD, UNIX, MICROSOFT WINDOWS, and the like.

In some embodiments, server 110 interacts with a plurality of communication terminals 120-1 to 120-n via a communication network. Each of the communication terminals, as 120-1 also includes one or more processors as CPU 121, support circuits 123, and a memory 124 containing an operating system 125 and applications 126. Also associated with the communication terminal 120-1 in some embodiments is a display device (not shown) which may comprise a touch screen able to accept input from a user's finger or input from a stylus. In some embodiments, applications 126 include a communication session module configured, by execution of instructions by CPU 121, to set up a telephone call or send an SMS, IM chat, or MMS message to an intended recipient via the communication network.

Message manager module 118 includes a message management agent 160 comprising a communication session manager 162 for directing the exchange of messages between the server 110 and the communication terminals 120-1 to 120-n, and a message formatter/re-formatter 164 for substituting a unique media file identifier for a media file specified, by a message author, for inclusion in or attachment to a message to be sent to one or more recipients. As previously described, the formatting applied to a particular message in accordance with the specification of a media file already having an association with a unique identifier is performed without the involvement or awareness of the message author. If a message specifies one or more media files to be uploaded to a server or otherwise forwarded to a recipient via one of messaging servers 130, 140 or 150, such media files may or may not actually be uploaded depending on whether an association with a unique file identifier already exists. From the point of view of the sender and recipient(s) utilizing a message editing/sending user interface according to embodiments consistent with the present invention, however, all media files are processed in the same way.

In some embodiments, message manager agent 160 further includes a notification generator 166 or manager for generating prompts and alerts to be sent or presented to the users of terminals 120-1 to 120-n, based on the availability of a media file forwarded at the request of a particular sender. In some embodiments, if File ID identifier 184 of media file management module 180 determines that the media file has already been sent to the recipient by a different sender, notification generator 166 may generate a notification to that effect, alerting one or both of the most recent (redundant) sender and the recipient(s) that the media file is available to the sender for download upon, for example, selection of a user interface download option, but also identifying the date on which the same file was previously transmitted and/or the username or other contact details of the previous sender.

Likewise, if File ID Identifier 184 determines that no unique identifier already exists for the media file(s) being submitted by a sender, then such a unique identifier is generated by File ID Assignor 182 and stored in memory 104 either in association with a locally stored copy of the media file or in a media file profile stored in a media file profile database 172 of data repository 170. To facilitate the reformatting of messages so as to incorporate media file attachments or addresses for download according to associations with unique identifiers, data repository 170 of message manager module 118 further contains, in some embodiments, one or more message content formatting templates 173, and user account settings 174. The user account settings 174 may include user notification preferences 176 specifying, for example, the form and/or manner of notifying a recipient when media content is received and/or available for download. The form of the notification may be the same for all messages including a media file but different from the notification applicable to other messages. By way of example, arrival or availability of a message including an audio media file might be audibly announced, or by invocation of a device's “vibrate mode”, if such capability is present, while the arrival of other messages incorporating visually accessible media content are not announced in this manner, or are announced in an audibly distinguishable manner.

Alternatively, or in addition, account settings 174 may provide that certain messages are visually distinguishable in a list presented to a recipient, in accordance with some embodiments, based on the presence (or absence) a media file attachment or network address for downloading the media file. For example, a display device such as mobile terminal, tablet, notebook or desktop computer, or even a desktop phone with a suitable display, might present the user with a list of messages in which media content-associated messages are color coded to distinguish them from messages lacking an association with such content. In some embodiments, user account settings 174 may associate a different color and/or audible alert with media files sent by a particular sender. To facilitate default settings consistent with the capabilities of different communication terminals, user account settings 174 may further include device profiles 178.

Device profiles 178 contain information relating to communication terminals known to be associated with a user. The information, which may relate to the size and resolution of a display, the type(s) of user input accommodated by the device (e.g., touchscreen, mouse, soft and/or assigned device buttons, speech recognition, and the like). The availability of such information, in accordance with some embodiments, enables the system 100 to match the particular notifications, alerts and reformatted presentation of message contents to the capabilities of the particular device a message author and/or recipient happens to be using.

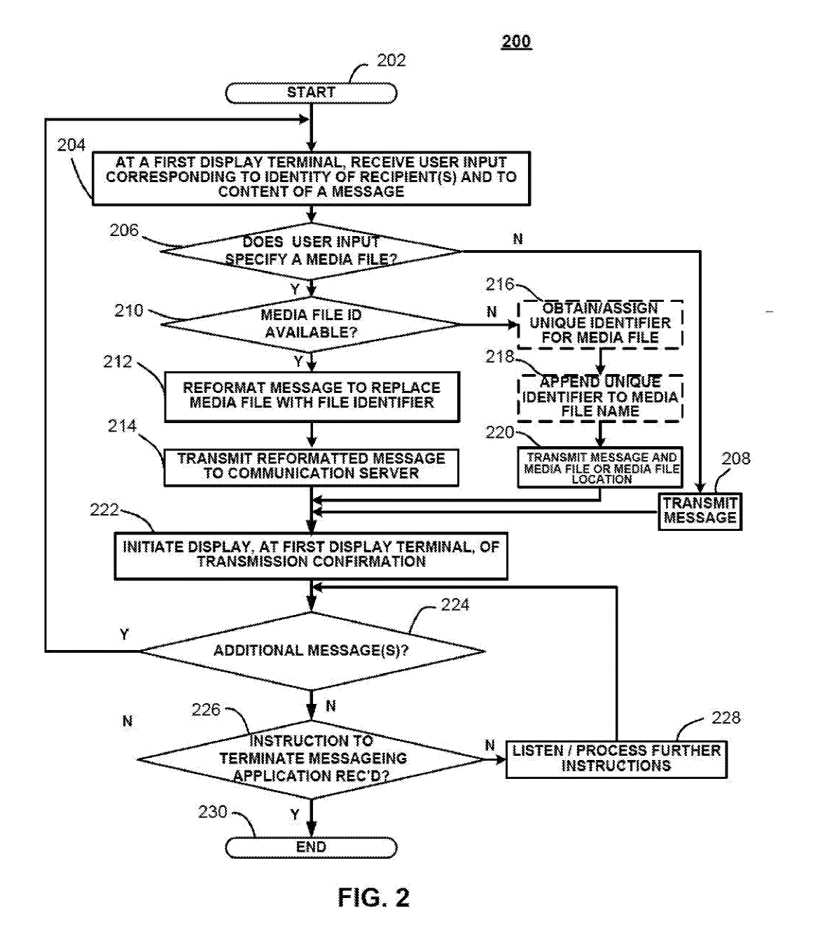

FIG. 2 is a flow diagram of a method 200 for managing the creation of message content specifying one or more media file attachments, at a first or “sender” user communication terminal, to facilitate efficient delivery of media files to one or more recipients' communication terminals according to one or more embodiments consistent with the present disclosure. The method 200 starts at 202, and generally proceeds to 204.

At 204, user input is received corresponding to the content of a message and/or to the identity of one or more recipients. If present, an identity may specify a particular intended recipient by username or “handle”, or plurality of such intended participants, or an identifier which corresponds to members of a group who have “subscribed” or joined together to exchange messages on one or topics of collective interest. In embodiments, a message author provides the user input by invoking a graphic user interface (GUI) of a communication terminal. Typically, the GUI comprises a message editing window presented via the display, and it may further include a menu displayed for the purposes of identifying and/or selecting the network address and/or username/handle of the intended recipients or group for which the message is intended. Other information rendered to the display as part of the menu may, for example, comprise the name of the intended recipient(s) or group(s), a list of phone numbers, SIP addresses, and/or e-mail addresses stored in a local memory of the communication terminal and applicable to the intended recipient. In such embodiments, method 200 may be implemented entirely by a mobile terminal such, for example, as a smartphone, personal digital assistant (PDA), tablet, laptop computer, or the like. In other embodiments, some or all of the information accessed for display of the menu may be stored at a server, wherein the menu invoked by the GUI constitutes part of a communication client application as, for example, an application configured to initiate message exchanges, as well as telephone conversations, handled by a remote server.

The method 200 proceeds to 206, where a determination is made as to whether the received user input specifies a media file to be uploaded to a messaging server for delivery to one or more recipients. If not, the method 200 proceeds to 208. At 208, the message authored by a communication terminal is transmitted via a communication network to one or more recipients. In an embodiment, the message is first received at a server and forwarded to respective communication terminals each associated with a corresponding one of the one or more recipients. If the user input does specify that the media file is to be uploaded to a messaging server, method 200 proceeds to 210.

At 210, a determination is made as to whether a unique media file identifier is associated with any media file specified for uploading and delivery to one or more recipients. If so, the method 200 proceeds to 212. In some embodiments, the unique media file identifier comprises a QL (quick load) header which comprises a unique identifier designated herein as a QL identifier and, optionally, indicia of a date of creation or last modification to the media file. The QL header is appended to the pre-existing file name of the media file as part of a locally or remotely performed renaming process. The renaming approach ensures that the media file name is readily recognized by the media file author even after the QL header has been appended.

Although the accompanying Figures and corresponding discussion depict realization of the unique media file identifier as a QL identifier within a QL header, the designation of a media file as “unique” (i.e., when compared to other media files in a repository or collection of repositories) may be implemented in other ways. For example, a unique media file identifier and other metadata may be stored (e.g., embedded) within in the media file itself. Alternatively, each media file may be identified by its original or some other file name, and/or by a network address, in a database which associates each respective media file with a corresponding unique identifier. In some embodiments, a local (i.e., communication endpoint) version of such a database contains only those media files and unique identifiers applicable to locally stored media files while a server-side version of such a database contains media files and corresponding media files associated with many subscribers.

In embodiments, a media file author or originator operates a communication endpoint executing a media file transfer application to initiate transmission of a media file which the operator has never sent to anyone using the application before (e.g., a newly created media file). The media file transfer application requests and acquires a unique QL header from a remote administration server. Once acquired, the QL header is locally appended to the media file name and the endpoint executing the media file transfer application may then be operated to initiate the first transmission of the renamed media file via the same or a different server. In subsequent transmissions of the same media file by the same user (e.g. to other intended recipients) from the same endpoint, only the unique identifier, rather than the entire media file, need be transmitted. For example, a processor of such a communication endpoint need only execute locally stored instructions for extracting the unique identifier from the media file name.

In embodiments, a different communication endpoint operated by the same or a different media file originator may request, and obtain, a unique identifier for a media file already stored at a server and for which an association with a previously assigned unique identifier already exists at the server. To avoid duplication, the server may perform a comparison of the incoming media file with every stored media file previously received from the same originating user or, for that matter, from every originating user subscribing to server-mediated media file transfer services in accordance with one or more embodiments. Where a duplicate is found, the server may, but need not, transmit the pre-existing QL header to the later-sending endpoints, along with an instruction to update the media file name.

In some embodiments, the computational complexity associated with the avoidance of storing duplicates from the same subscriber may be avoided by centralizing the storage of those of subscriber's media files updated with a unique identifier. For example, media files containing the QL header or stored in a database in associate with metadata may be centrally stored at a server or, alternatively, at a designated endpoint of a plurality of endpoints associated with a single subscriber. In other embodiments, each QL header is generated and appended to a corresponding media file only after the media file is received at a server and a search for duplicates, among the pre-existing media files in the applicable file repository, has been performed. Such an approach obviates the assignment of duplicate unique identifiers in the first place.

Returning now to FIG. 2, it will be seen that at 212, the message generated from received user input is reformatted so as to specify the unique media file identifier rather than incorporate the media file itself (e.g, as an attachment). From 212, method 200 proceeds to 214 where the reformatted message is transmitted to a communication server. If, however, a determination is made at 210 that no unique media file identifier is presently associated with a media file specified for uploading and delivery to one or more recipients, then the method 200 proceeds either directly to 220, where a message including either a media file storage location (for cloud-based applications in which the media file to be sent is stored remote from the subscriber's communication endpoint) or the media file itself is uploaded for delivery to one or more recipients, or to 216, were a unique identifier is first assigned to and/or obtained for the media file. In the latter case, the unique identifier may be stored locally at the communication terminal in association with the media file or the name of the media file. In an embodiment, method 200 proceeds from 216 to 218, where the unique identifier is appended to the file name of the media file in accordance with a file naming convention.

From 208, 214, or 220, method 200 proceeds to 222 where display of a confirmation of transmission to the recipients is initiated at the sending user's communication terminal. From 222, method 200 proceeds to 224, where a determination is made as to whether any additional messages are to be transmitted. If so, the method 200 returns to 204 and iterates 204 to 222. If not, the method proceeds to 226, where a determination is made as to whether an instruction to terminate the messaging application has been received. If not, the method proceeds to 228, where method 200 continues to listen for and, if applicable, process, further instructions as received. If so, the method 200 proceeds to 230 and terminates.

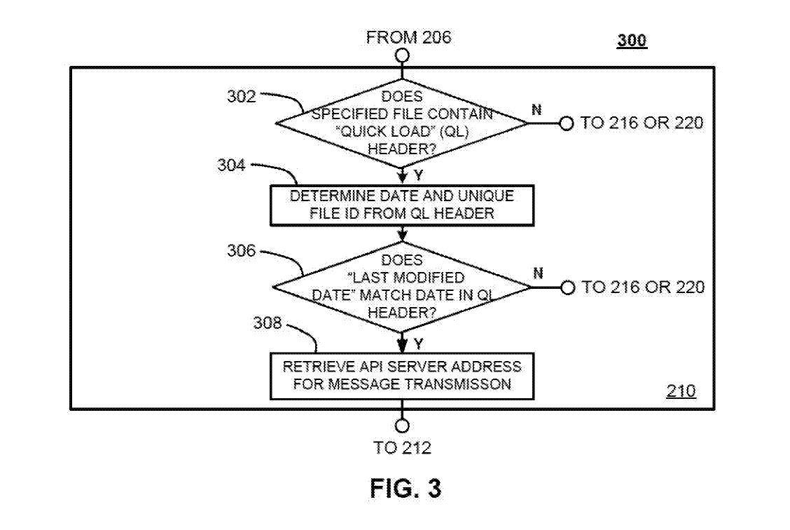

FIG. 3 is a flow diagram of a method 300 for specifying one or more unique media file identifiers to facilitate efficient delivery of media files to one or more recipient communication terminals, as, for example, a sub-process of the method 200 of FIG. 2, according to one or more embodiments consistent with the present disclosure. In some embodiments, the method 300 is entered at 302, where method 300 launches, by execution of instructions by a processor of a communication terminal such as a first communication terminal, a message authoring, editing, and/or access application. From 302, method 300 proceeds to 304, where a determination is made as to whether a media file specified in a message generated by a user of the first communication terminal contains a quick load (QL) header as part of its file name.

If not, the method 300 returns to method 200 via 216 or 220. If so, however, the method 300 proceeds to 304 where the QL header is inspected to determine the unique file ID associated with the media file and, optionally, a date of creation and/or most recent modification of the media file.

From 304, the method 300 proceeds to 306, where a determination is made as to whether the creation or last modified date of the specified media file matches the data determined from the QL header. In the embodiment of FIG. 1C, for example, if a QL header is present, it is extracted by File ID identifier 184. If not, the method 300 returns to method 200 via 216 or 220. If so, the method 300 proceeds to 308. At 308, an API server address is retrieved for use in directing a message specifying the media file to the appropriate port of a messaging server configured to retrieve the appropriate media file and making the same available for retrieval by a recipient (or by automated delivery to the recipient). From 309, the method 300 returns to method 200 via 212.

As noted previously, in other embodiments, the filename itself is not the means by which a unique file identifier is associated with a media file. For example, local indexing—where the QL-code/file association is not stored with the file itself, but separately such that it is still accessible to the communication endpoint on a local basis—may be employed. In the latter regard, “local” as used herein may mean physical local storage associated with the communication end or another endpoint connected to it by a peer to peer or local area network link, or to a storage location at a remote server. In the latter case, the communication endpoint may retrieve the document by downloading and then forward it, or the communication endpoint may simply specify the network storage location from which the media file transfer server may down load the media file. It suffices to say that processing of media files in accordance with one or more embodiments of the present disclosure minimizes and/or obviates duplicate uploads from a communication endpoint to a media file exchange service provider.

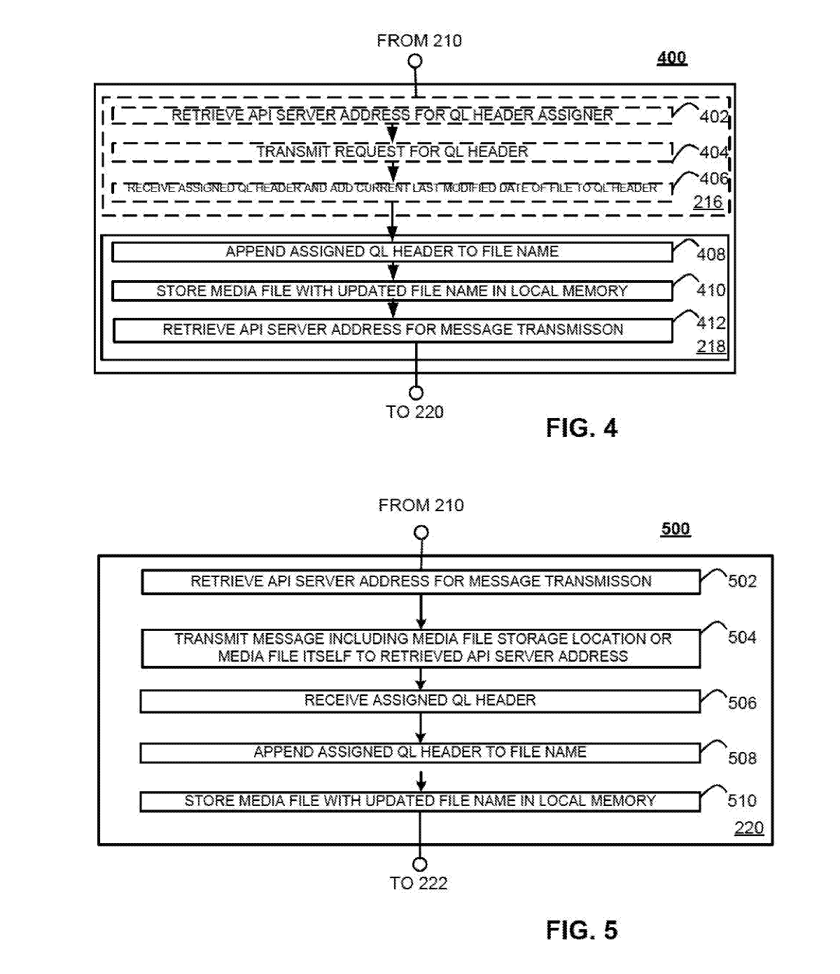

FIG. 4 is a flow diagram of a method 400 for associating one or more media file unique identifiers with one or more corresponding media files to facilitate efficient delivery of media files to one or more recipient communication terminals, as, for example, a sub-process of the method 200 of FIG. 2, according to one or more embodiments of consistent with the present disclosure. In some embodiments, the method 400 is entered at optional operation 402, where method 400 retrieves, by execution of instructions of a processor of a communication terminal such as a first display terminal server, an API server address for use in obtaining, for a media file specified in a message authored by a user of the first communication terminal, a QL header that can, for example, be stored locally at the first communication terminal in association with the media file and remotely, at a server, in association with a copy of the media file according to one or more embodiments.

From 402, the method 400 proceeds to 404, where the first communication terminal transmits a request for the QL header to remote server. In embodiments, the transmission of the request precedes uploading of the media file to (or its retrieval from a subscriber-specified network address by) the media file transfer server. Indeed, if a copy of the media file already exists in storage accessible by the server to which the request is directed only the media file storage location need by the sent by the subscriber. If such a copy already exists at the server, and a QL header has already been assigned to the copy, then at 406, the first communication terminal receives the pre-existing QL header for association with the locally stored version of the media file. If no such copy exists, then at 406, the first communication terminal receives a newly generated unique media file identifier for association with the locally stored version of the media file.

In embodiments, a newly assigned QL identifier (i.e. one for which no media file has yet been uploaded from the endpoint which requested it) is distinguished from an older one (i.e., one for which a media file has been uploaded and made accessible to the server) via a Yes/No flag in the QL header. The value of the Yes/No flag changes from N to Y when the endpoint uploads the media file for the very first time. Optionally, the flag toggles back to No once the media file is modified and/or its checksum no longer matches that of the original version of the media file. In an embodiment, a message instructing the server to delete the obsolete prior copy and, optionally, re-assign the QL identifier. In alternative embodiments, QL acquisition functions served by 402, 406 and 406 are obviated by a local QL generation process, wherein instructions executed by the processor of the first communication terminal determine that for locally generated, original content such as spreadsheets, presentations and documents, or photos and video captured with an onboard camera, a unique identifier can be locally generated and assigned to the media file without the risk of a duplicate media files being stored by the server.

In any event, once a QL header has been assigned and/or received, the method 400 proceeds to 408. At 408, the QL header is appended to the filename of the media file and, at 410, the “renamed” media file is stored in local memory of the first communication terminal. In alternative embodiments, the data corresponding to the QL header may be represented as metadata sent along with the file or embedded as part of the media file itself. A checksum for file comparison may also be generated and submitted with the media file. From 410, method 400 proceeds to 412. At 412, the API server address associated with a port of a messaging server configured to receive messages containing one or more media file(s) and, optionally, correspondingly assigned unique identifiers, is retrieved. From 412, method 400 returns to method 200 via 220.

FIG. 5 is a flow diagram of a method 500 for associating one or more unique identifiers, such as the QL identifier discussed in previous examples, with one or more corresponding media files or media file storage locations to facilitate efficient delivery of media files to one or more recipient communication terminals, as, for example, sub-process 220 of the method 200 of FIG. 2, according to one or more embodiments consistent with the present disclosure, wherein the media file and/or media file storage location is transmitted to a media file transfer server along with an assigned QL header. The method 500 is entered at 502, where method 500 selects and retrieves an API server address for message transmission. From 502, the method 500 proceeds to 504 where a message including a media file to be retrieved is transmitted to the retrieved API server address. From 504, the method 500 proceeds to 506 where a QL header assigned by the server is received and, at 508, the received QL header is appended to the file name of the media file. So renamed, the media file is stored at 510 so that it replaces the version previously stored at the communication terminal. From 510, the method 500 returns to method 200 via 222.

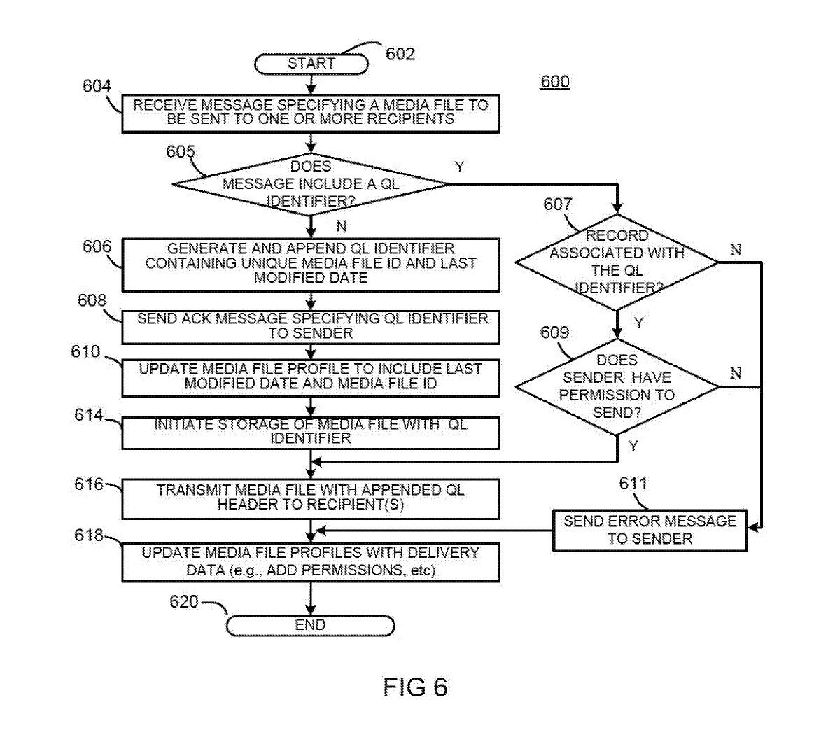

FIG. 6 is a flow diagram of a method 600 for server-based processing and/or presenting received messages, specifying one or more media files to be sent to one or more recipients, to facilitate the efficient transfer of media files to recipient communication terminals, according to one or more embodiments consistent with the present disclosure. The method 600 is entered at 602 and proceeds to 604. At 604, method 600 receives a first message which specifies a media file to be sent on behalf of the user of a first communication terminal to one or more recipients. The media file may, for example, be specified by attaching the file to a message using a text messaging, MMS, or email application. Alternatively, or in addition, media file may be specified by including a uniform resource locator (URL) or file transport protocol (FTP) address from which the media file may be downloaded. From 604, the method 600 proceeds to 605.

At 605, a determination is made as to whether a QL identifier or other unique media file identifier is included in or forms part of the media file specification. In an embodiment, a unique identifier is determined to be present when a QL header is appended to the file name of the specified media file. The QL header consists of a series of alphanumeric characters uniquely assigned so that it corresponds to precisely one media file or, if applicable, a collection of media files. Optionally, the QL header may further include a six digit field corresponding to the day, month, and year of file creation and/or last modification. In some embodiments, the QL header may uniquely identifier the initial sender of the media file and/or a recipient group identified by the sender as having forwarding privileges.

If, at 605, it is determined that a unique identifier is associated with a media file specified in a message, method 600 proceeds to 607 where a determination is made as to whether a record associated with the unique identifier exists. A message specifying a media file may comprise a media file that includes a unique media file identifier (e.g., as embedded information within the file itself or as a QL header appended to the name of the media file). A message specifying a media file may, alternatively comprise a unique media file identifier without the corresponding media file. Finally, a message specifying a media file may comprise just the media file without any unique media file identifier.

In an embodiment, a database linking the storage locations of previously processed media files to corresponding unique identifiers (i.e., QL identifiers which have been assigned during a prior media file transfer process) is examined to determine if a record already exists for the unique identifier specified in the message received at 604. The presence of a unique identifier in the message received at 604 facilitates the determination in that the presence of the unique identifier in the database confirms that a media file has already been received and stored for use by the media file exchange server or, in the alternative, that a unique identifier has been reserved by an endpoint for a future upload.

Where the media file is received at 604 without a unique identifier, a determination may still be made at 605 in accordance with one or more embodiments. For example, the received media file may be compared, bit-by-bit with all of the media files within the database having, for example, the same file size and/or file creation date. Because a bit-by-bit comparison may miss systematic corruptions which might occur to both files, a checksum (hash or hash) of each media file may be generated, sent, and stored with each media file in the server repository, to facilitate future comparison. Likewise, the same checksum might be performed by the endpoint and included with the message, to speed up the media file examination process.

In an embodiment, the record includes a network address or other location from which a copy of a media file associated with the unique identifier can be accessed. If so, method 600 proceeds to 609 where a determination is made as to whether the prospective sender of the media file has permission to send the media file. In an embodiment, a determination is made that such authorization exists when the prospective sender is identified by an entry in a media file profile database which confirms previous receipt of the media file from another sender. If the determination is negative, the method 600 proceeds to 611, where an error notification is generated and sent alerting the sender. In alternate embodiments, a message may be automatically sent for forwarding authorization to one or more individuals who are in the contact list of the prospective sender and for whom an entry does exist in the media file profile database. If the determination is positive, method 600 proceeds to 616 where the server transmits a stored copy of the media file to the recipient(s) on behalf of the requesting sender.

If, at 605, it is determined that the message specifying the media file to be sent to one or more recipients is not already associated with a unique identifier, method 600 proceeds to 606 where a unique identifier is generated and stored in association with media file at a server. In an embodiment, the unique identifier comprises a QL header as previously described and the association is made by appending the QL header to the file name of the media file. In alternate embodiments, the unique identifier and file name of the media file are associated with one another in a media profile database. In other embodiments, or in addition, other data within the body of a file itself may be modified to include the same components as a QL header (e.g., a unique identifier plus a last modified date). As discussed previously, information incorporated in the QL header and/or in the media file database may include a unique alphanumeric identifier, the name of each prior sender and recipient of the media file, and the date on which the media file was created or last modified. The method 600 proceeds to 608.

At 608, an acknowledgement message is sent from the server to the communication terminal operated by the sender of the message received at 604. In an embodiment, the acknowledgement message notifies the sender device that the request was received and optionally, in a manner not perceivable by the sender, provides the unique identifier for local storage at the communication terminal in association with the specified media file. As well, at 610, a new media file profile is created for the media file and it is updated to include the unique identifier, an identity of the sender and recipient(s) (e.g., including for each a network address, telephone number, and/or e-mail address), and the last modified or file creation date. From 610, method 600 proceeds to 614, where storage of the unique identifier and a copy of the media file is initiated at, for example, a media server from which a messaging server and/or intended recipients can retrieve the media file. From 614, the method proceeds to 616, where the copy of the media file and unique identifier are made available to the recipients. In some embodiments, the media file and unique identifier is transmitted automatically to the recipients. In alternate embodiments, the original message from the sender is reformatted at the server so as to identify an address from which the media file can be downloaded. At 618, the media file profiles are updated with delivery data and, at 620, the method 600 terminates.

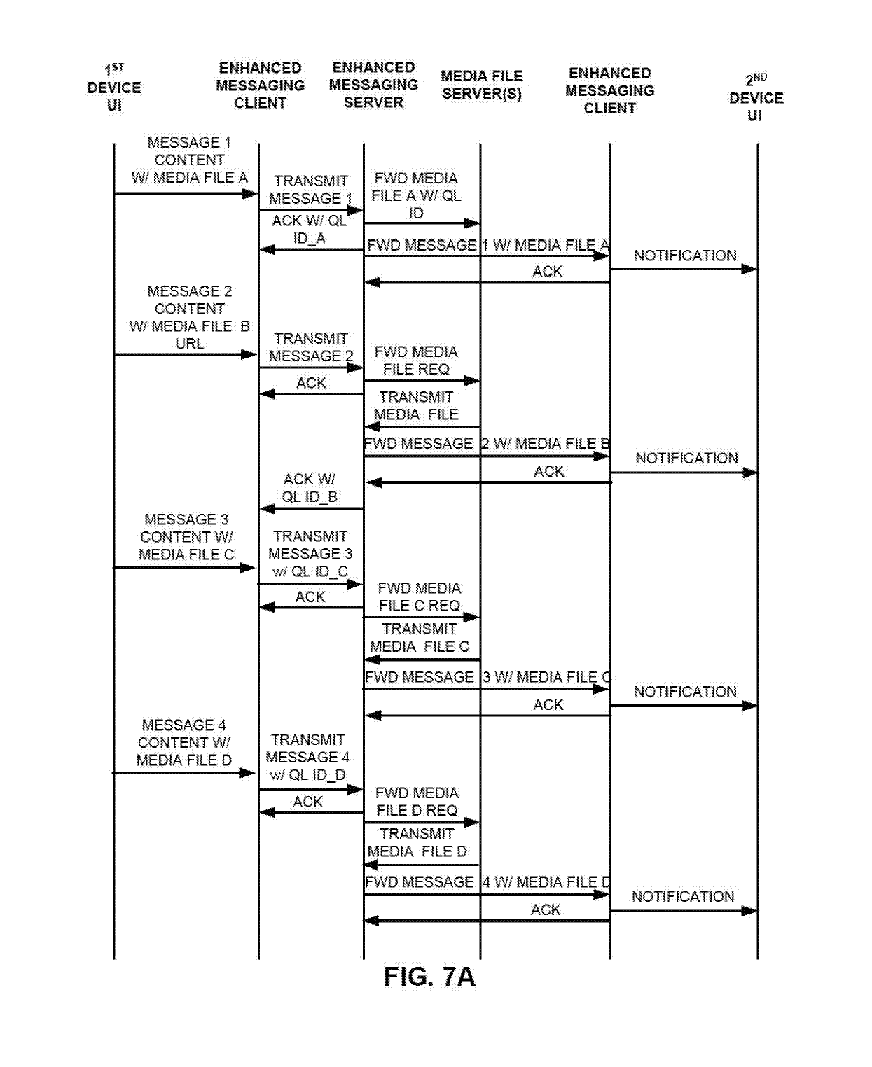

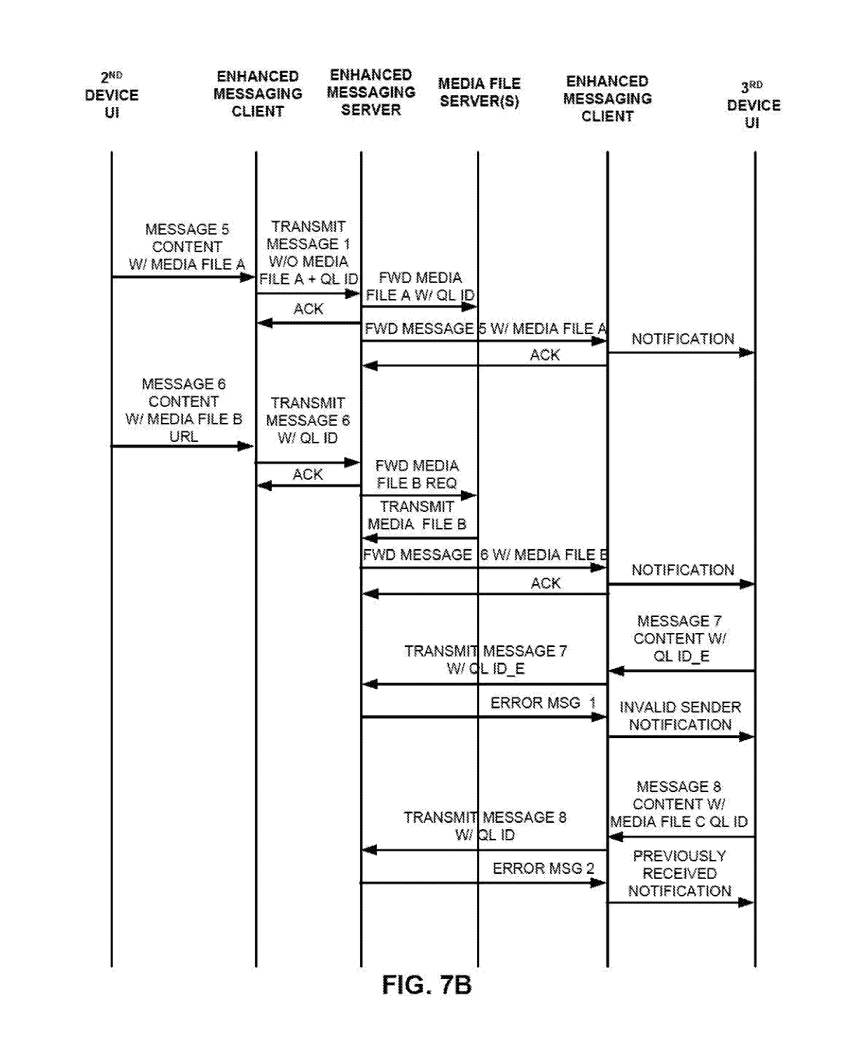

FIG. 7A is a message flow diagram depicting the development, flow and processing of messages between a first message exchange participant (e.g., a sender) and a second message exchange participant (e.g., a recipient), at least some of the messages specifying media files to be received and/or accessed and presented to message recipients in accordance with one or more embodiments. In embodiments exemplified by FIG. 7A, a series of messages originate at a first communication terminal device on which an enhanced messaging client is executed by a processor. The messages are intended to be accessed and reviewed by a group of one or more recipients which includes the user of a second communication terminal device on which an enhanced messaging client is executed by a processor. The first message (“Message 1”) specifies media file A by requesting attachment of that file to the message, while a second message (“Message 2”) includes specifies media file B by incorporating a media file download address (e.g., a URL) in the body of the message.

If neither media file A nor media file B have ever been submitted by subscribing communication terminal users, no association can be made at the enhanced messaging server between either of these media files and a unique identifier. In some embodiments, the enhanced messaging server responds to the lack of an association by transmitting, to the first communication terminal, an acknowledgement message that includes a newly generated QL identifier or other unique identifier. As well, a copy of the media file A is forwarded to a media server for storage in association with the unique identifier. In an embodiment, a copy of the media file B is retrieved from the address specified in Message 2 and forwarded to a media server. Each of Messages 1 and 2, including the media files A and B, respectively, and corresponding unique identifiers, are sent to the second communication terminal and processed by an enhanced messaging client whose instructions are executed by a processor of the second communication terminal.

With continued reference to FIG. 7A, it will be seen that Messages 3 and 4 specify, for delivery to the second communication terminal, media files C and D, respectively. However, an association already exists—both at the enhanced messaging server and the first communication terminal—between these media files and a corresponding unique identifier. As such, though the user of the first communication terminal may use an enhanced messaging client to construct a message attaching one of these media files and believe he or she is in fact uploading such files, in reality only the unique identifier for these media files is included in messages 3 and 4, respectively.

Where FIG. 7A exemplifies the flow of messages from a sender who may or may not be the creator of the media files C and D, FIG. 7B is a flow diagram depicting the development, flow and processing of messages between a first recipient and a subsequent recipient where at least some of the messages specify a media file for which an association with a unique identifier already exists at a server and one of the sender communication terminals.

In embodiments exemplified by FIG. 7B, a series of messages originate at a second communication terminal device or a third communication terminal device on which a corresponding enhanced messaging client is executed by a processor. The first two messages (“Message 5” and “Message 6”) are directed at the user of the third communication terminal and specify media files A and B, respectively. Because the user of the second communication terminal previously received media files A and B from the user of the first communication terminal (FIG. 7A), an association already exists between a unique identifier (QL ID) and the corresponding media file. As such, the enhanced messaging client executing on the second communication terminal does not actually upload the media file A, as directed by the user of the second communication terminal, but rather sends a message which specifies the applicable QL ID (i.e., QL ID_A) instead.

Message 7 is directed at the user of the second communication terminal. In this example, the QL_ID for media file E specified by Message 7 may or may be valid (i.e. correspond to a media file that resides on one of the media servers accessible to the enhanced messaging server). As a security feature, embodiments of the present disclosure may process a request to transfer a media file based on an examination of the prior activity associated with that media file. For example, based on a determination that the user of the third communication device is not a prior recipient of the media file E corresponding to that unique identifier, the file transfer request to the user of the second communication terminal is refused by the enhanced messaging server and a notification to that effect is transmitted to the third communication terminal.

Message 8 is also directed at the user of the second communication terminal. In this example, the QL_ID for media file C specified by Message 7 is valid (correspond to a media file that resides on one of the media servers accessible to the enhanced messaging server). Moreover, for purposes of the example, the media file C was received from the user of the first communication terminal (FIG. 7A). However, based on a determination that the user of the second communication device already received media file C from another user (i.e., the user of the first communication terminal as shown in FIG. 7A), the file transfer request to the user of the second communication terminal is refused (or deferred) by the enhanced messaging server and a notification to that effect is transmitted to the third communication terminal.

In an alternative embodiment, instead of refusing the transfer outright, a modified message may be generated by the enhanced messaging server which specifies the applicable QL_ID so that a user operating the second communication terminal according to the enhanced messaging client may view a message which incorporates the locally stored version rather than one redundantly supplied by the enhanced messaging server. In a further embodiment, the enhanced messaging server may defer a decision to send to media file until it determines that a locally stored version of that media file is still available at the second communication terminal. Such a determination may be made, for example, by the enhanced messaging server sending a query to the enhanced messaging client and awaiting a reply.

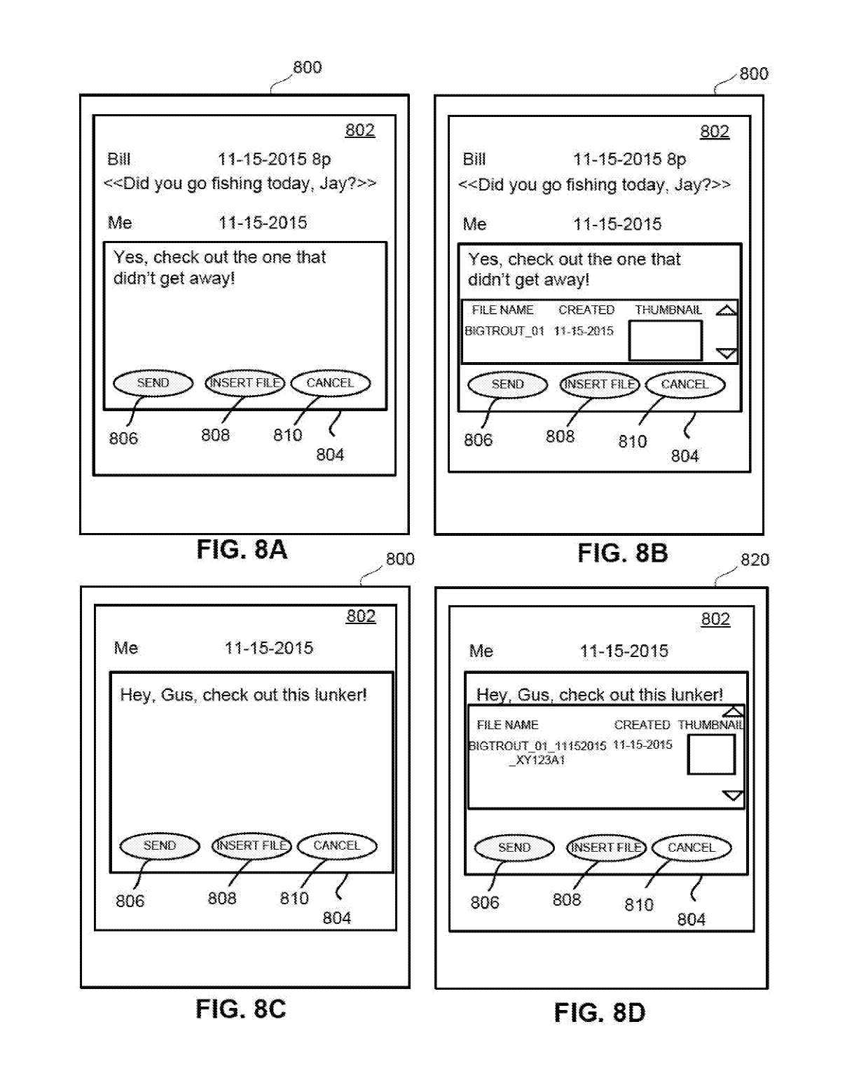

FIG. 8A depicts a communication terminal 800 operated by a user to visually present a sequence of messages forming at least part of a first message exchange between two or more participants and to create, edit or forward a message specifying one or more media files for delivery to one or more recipient(s), according to one or more embodiments consistent with the present disclosure. The sequence of messages are rendered to a display 802, which also provides a text editor window 804 for the user of communication terminal 800 to construct a message and to send the message, append one or more media files to the message, or cancel the operation using displayed feature buttons 806, 808 and 810, respectively. By electing to append a file to the message, as by touch screen or mouse click input, the window 804 is rendered to display 802, as shown in FIG. 8B

FIG. 8B depicts the communication terminal 800 of FIG. 8A following the processing of received message content and depicts an exemplary manner in which one or more media files may be selected for association with a message (e.g. as a file attachment), according to one or more embodiments. Here, each of the files stored in a memory of the communication terminal 800 may be selected by scrolling up or down within window 802. One or more lines within window 804 may be highlighted such that a single file or many files can be attached using the insert file feature button 808.

FIG. 8C depicts the communication terminal 800 of FIGS. 8A and 8B operated by a user to construct a message intended for a second recipient, according to one or more embodiments. Here, the same process and feature buttons as previously described are employed, but in some embodiments any media files which have been previously sent by communication terminal 800 are renamed so as to incorporate a unique identifier in the file name, or their file names are associated with a respectively unique identifier via, for example, a local data table. In the former regard, FIG. 8D depicts the communication terminal 800 of FIGS. 8A to 8C operated by a user to construct a message intended for the second recipient but specifying the same media file content as that specified for delivery to a first recipient as shown in FIG. 8B, according to one or more embodiments. It can be seen that the file name has been amended by appending a unique identifier XY123A1 and a series of digits corresponding to a date of creation or last modification (Nov. 15, 2015).

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, embodiments of the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of embodiments of the present invention may be written in an object oriented programming language, such as Java®, Smalltalk or C++, and the like. However, the computer program code for carrying out operations of embodiments of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit embodiments of the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

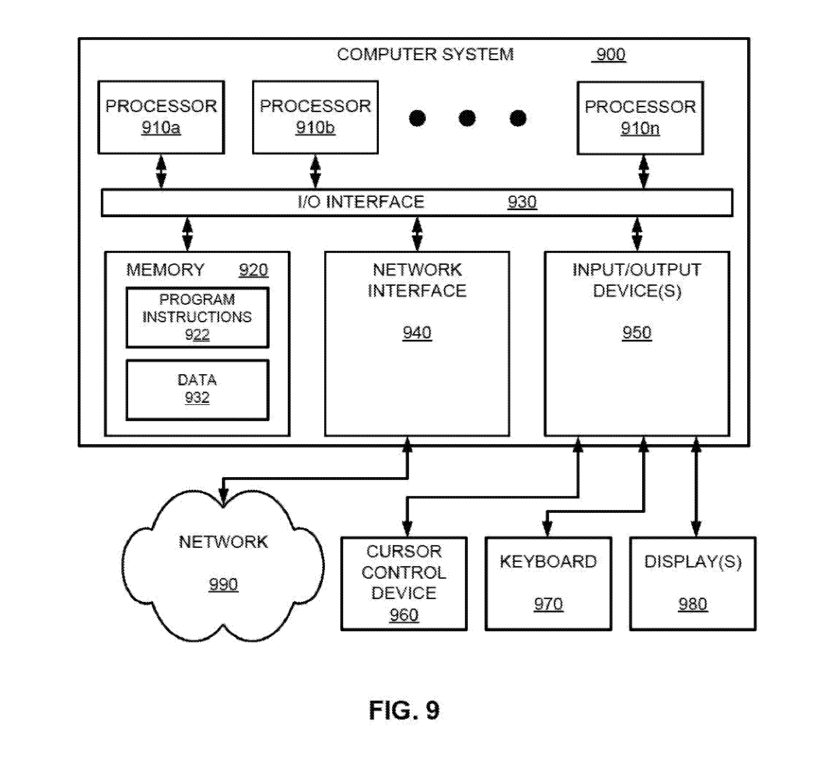

FIG. 9 is a detailed block diagram of a computer system, according to one or more embodiments, that can be utilized in various embodiments of the present invention to implement the computer and/or the display devices, according to one or more embodiments.

Various embodiments of method and apparatus for organizing, enhancing and presenting message content which incorporate one or more media files, as described herein, may be executed on one or more computer systems, which may interact with various other devices. One such computer system is computer system 900 illustrated by FIG. 9, which may in various embodiments implement any of the elements or functionality illustrated in FIGS. 1-8D. In various embodiments, computer system 900 may be configured to implement methods described above. The computer system 900 may be used to implement any other system, device, element, functionality or method of the above-described embodiments. In the illustrated embodiments, computer system 900 may be configured to implement method 200 (FIG. 2), method 300 (FIG. 3), method 400 (FIG. 4), method 500 (FIG. 5), method 600 (FIG. 6), method 700 (FIG. 7A) and/or method 710 (FIG. 7B) as processor-executable executable program instructions 922 (e.g., program instructions executable by processor(s) 910) in various embodiments.

In the illustrated embodiment, computer system 900 includes one or more processors 910a-910n coupled to a system memory 920 via an input/output (I/O) interface 930. Computer system 900 further includes a network interface 940 coupled to I/O interface 930, and one or more input/output devices 950, such as cursor control device 960, keyboard 970, and display(s) 980. In various embodiments, any of the components may be utilized by the system to receive user input described above. In various embodiments, a user interface may be generated and displayed on display 980. In some cases, it is contemplated that embodiments may be implemented using a single instance of computer system 900, while in other embodiments multiple such systems, or multiple nodes making up computer system 900, may be configured to host different portions or instances of various embodiments. For example, in one embodiment some elements may be implemented via one or more nodes of computer system 900 that are distinct from those nodes implementing other elements. In another example, multiple nodes may implement computer system 900 in a distributed manner.

In different embodiments, computer system 900 may be any of various types of devices, including, but not limited to, a personal computer system, desktop computer, laptop, notebook, or netbook computer, mainframe computer system, handheld computer, workstation, network computer, a set top box, a mobile device such as a smartphone or PDA, a consumer device, video game console, handheld video game device, application server, storage device, a peripheral device such as a switch, modem, router, or in general any type of computing or electronic device.

In various embodiments, computer system 900 may be a uniprocessor system including one processor 910, or a multiprocessor system including several processors 910 (e.g., two, four, eight, or another suitable number). Processors 910 may be any suitable processor capable of executing instructions. For example, in various embodiments processors 910 may be general-purpose or embedded processors implementing any of a variety of instruction set architectures (ISAs). In multiprocessor systems, each of processors 910 may commonly, but not necessarily, implement the same ISA.

System memory 920 may be configured to store program instructions 922 and/or data 932 accessible by processor 910. In various embodiments, system memory 920 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 920. In other embodiments, program instructions and/or data may be received, sent or stored upon different types of computer-accessible media or on similar media separate from system memory 920 or computer system 900.

In one embodiment, I/O interface 930 may be configured to coordinate I/O traffic between processor 910, system memory 920, and any peripheral devices in the device, including network interface 940 or other peripheral interfaces, such as input/output devices 950. In some embodiments, I/O interface 930 may perform any necessary protocol, timing or other data transformations to convert data signals from one component (e.g., system memory 920) into a format suitable for use by another component (e.g., processor 910). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. Also, in some embodiments some or all of the functionality of I/O interface 930, such as an interface to system memory 920, may be incorporated directly into processor 910.

Network interface 940 may be configured to allow data to be exchanged between computer system 900 and other devices attached to a network (e.g., network 990), such as one or more display devices (not shown), or one or more external systems or between nodes of computer system 900. In various embodiments, network 990 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 940 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 950 may, in some embodiments, include one or more communication terminals, keyboards, keypads, touchpads, scanning devices, voice or optical recognition devices, or any other devices suitable for entering or accessing data by one or more computer systems 900. Multiple input/output devices 950 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 940.

In some embodiments, the illustrated computer system may implement any of the methods described above, such as the methods illustrated by the flowcharts of FIGS. 2-6. In other embodiments, different elements and data may be included.

Those skilled in the art will appreciate that computer system 900 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 900 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A computer implemented method, comprising:
receiving, at a server, from a sender operating a communication terminal, a request for delivery of a media file to a first recipient;
determining, by execution of instructions by a processor, that the media file lacks association with a unique identifier;
initiating storage of a copy of the media file;
associating a unique identifier with the media file;
making available, to the first recipient, the stored media file copy;
receiving, at the server, a second request to deliver the media file;
determining that the copy of the media file is associated with the unique identifier; and
making available, to a second recipient, the stored media file copy.

2. The method of claim 1, wherein the request for delivery of the media file to a first recipient comprises a message having a media file attachment.

3. The method of claim 2, wherein the message is one of an e-mail message, an instant message, or a multimedia messaging service (MMS) message.

4. The method of claim 1, wherein the request for delivery of a media file to a first recipient comprises a message specifying a network address from which the media file can be retrieved.

5. The method of claim 1, wherein determining that the media file lacks association with a unique identifier comprises inspecting a file name of the media file for presence of an appended header.

6. The method of claim 5, wherein inspecting the file name comprises looking for characters representing a creation date.

7. The method of claim 1, further including receiving, at the server, a third request to deliver the media file;
determining that the sender of the third request is one of authorized to send the media file or a prior intended recipient of the stored media copy; and
making available, to a third recipient, the stored media file copy.

8. The method of claim 7, wherein determining that the sender of the third request is authorized comprises verifying that the sender of the third request previously downloaded the stored media file copy.

9. The method of claim 1, further including receiving, at the server, a third request to deliver the media file;
determining that the sender of the third request is not authorized to send the media file; and
transmitting an error message, over a communication network, to the sender of the third request.

10. The method of claim 1, wherein making the stored media file copy available to the first recipient comprises transmitting, over a communication network, a message including the including media file copy as an attachment.

11. The method of claim 10, wherein the message is one of an e-mail message, an instant message, or a multimedia messaging service (MMS) message.

12. The method of claim 11, wherein making the stored media file copy available to the first recipient comprises transmitting, over a communication network, a message specifying a uniform resource library (URL) address for downloading the media file copy.

13. The method of claim 1, further including transmitting, over a communication network, a message to the communication terminal, wherein the message specifies the unique identifier.

14. The method of claim 1, wherein the request for delivery of the media file to the first recipient specifies the unique identifier.

15. A computer implemented method, comprising:
at a first communication terminal, receiving user input corresponding to an identification of one or more recipients and to message content;
initiating display of the message content according to a user interface;
determining, by execution of instructions by a processor of the first communication terminal, that the received user input specifies a media file;
determining that the media file is identified by a unique identifier; and
transmitting, to a server, a message comprising the message content and the unique identifier.

16. The method of claim 15, further comprising:
at the first communication terminal, receiving second user input corresponding to an identification of one or more recipients and to second message content;
initiating display of the second message content according to the user interface;
determining, by execution of instructions by the processor of the first communication terminal, that the received second user input specifies a media file;
determining that the media file is not identified by a unique identifier; and
transmitting a message comprising the second message content and the media file specified by the received second user input.

17. The method of claim 16, further comprising assigning a second unique identifier to the second media file.

18. The method of claim 17, wherein the assigning is performed before transmitting the message comprising the second media file.

19. The method of claim 17, wherein the assigning includes receiving the second unique identifier from the server and associating the second unique identifier with the second media file in a memory of the first communication terminal.

20. A system for managing delivery of media files, comprising:
a display;
a transceiver;
a processor; and
a memory containing instructions executable by the processor
to receive user input corresponding to an identification of one or more recipients and to message content;
to initiate display of the message content according to a user interface;
to determine that received user input specifies a media file;
to determine that the specified media file is identified by a unique identifier; and
to initiate transmission, to a server, of a message comprising the message content and the unique identifier.
